(19) United States
(12) Patent Application Publication
(10) Pub. No.: US 2013/0088211 A1
(43) Pub. Date: Apr. 11, 2013

(54) DIRECT CURRENT CONVERTER WITH CUK-CIRCUITRY AND LOAD CURRENT DETECTION

(71) Applicant: Hella KGaA, Lippstadt (DE)

(72) Inventor: Volker Radtke, Delbruck (DE)

(73) Assignee: Hella KGaA, Lippstadt (DE)

(21) Appl. No.: 13/631,367

(22) Filed: Sep. 28, 2012

(30) Foreign Application Priority Data
Mar. 31, 2010 (EP) PCT/EP2010/054288

(51) Int. Cl. G05F 1/46

(52) U.S. Cl. CPC G05F 1/46
USPC 323/282

(57) ABSTRACT

The invention relates to a direct current converter with Cuk-circuit and a measuring resistor for load current detection, wherein the Cuk-circuit has a switching diode, and wherein the measuring resistor is arranged in series to the switching diode.

### CROSS REFERENCE

This application claims priority to PCT Application No. PCT/EP2010/054288, filed Mar. 31, 2010.

### TECHNICAL FIELD OF THE INVENTION

The invention relates to a direct current converter with Cuk-circuitry and a measuring resistor for load-current recording.

### BACKGROUND OF THE INVENTION

In addition to step-down converters, step-up converters and flyback converters, also converters with Cuk-circuitry are known from the prior art for the conversion of direct current or direct voltage to a direct current or direct voltage with a different magnitude. Input voltages of the converters may be raised or decreased by means of flyback converters and converters with Cuk-circuitry.

For the control of the output magnitude of a converter with Cuk-circuitry, as with other known direct current converters, the ratio of an on-time to an off-time of a controlled switch of the converter can be set. The ratio between the on-time to the off-time is of-ten selected depending on the load current. Often, the load current is to be controlled. To control the load current with converters with Cuk-circuitry, according to prior art, a signal is transmitted to a controller via a measuring resistor in the load circuit. Often, a pulse-width-modulation (PWM) is used for controlling.

Examples for direct current converters with Cuk-circuitry are for example described in the document “Designing a Boost-Buck (Cuk) Converter with HV9930/AT9933”, Supertex Inc.

Direct current converters with Cuk-circuitry have a controlled switch and a so-called switching diode, both serving the commutation of the current between different branches of the circuitry.

The output voltage of a direct current converter with Cuk-circuitry is always negative relative to the reference potential. The voltage measured at the measuring resistor in the load circuit is therefore negative and cannot be fed immediately into the standard micro-controllers, such as e.g. HV9930 by Messrs Supertex Inc., which are suitable for a signal having a positive voltage with regard to the reference potential. Currently, therefore, a signal matching, e.g. by means of inverters, is required.

An inverter stage, however, increases the circuit complexity and the tolerances.

### SUMMARY OF THE INVENTION

This is where the present invention comes into play.

The object of the present invention is to improve a direct current converter with a Cuk-circuitry so that a signal matching of the measuring signal by an inverter becomes superfluous.

This task is solved by connecting the measuring resistor in series to the switching diode.

In contrast to the prior art, the measuring resistor is not arranged in the load circuit of the direct current converter, but in a secondary circuit upstream of the load circuit, through which a current is passed only temporarily, i.e. when the controlled switch of the converter is open. The average value of the current indicated by measuring resistor does correspond to the load current, however, which is why it indirectly indicates the load current. As the load current of a direct current converter is a direct current, the load current still flows through the switching diode, even if a filter capacitor is connected in parallel to the output of the direct current converter.

The measuring resistor may be connected to a cathode of the switching diode with a first connection and to a reference potential of the direct current converter with a second connection. A capacitor may be connected in parallel to the measuring resistor. This capacitor may serve average determination.

According to the invention, the first connection of the measuring resistor may be connected to an input of an integrated circuit, particularly an operational amplifier or a microcontroller. The first connection of the measuring resistor may be connected to an integrator circuit. The integrator circuit may be part of the microcontroller.

An output of the integrator circuit may be connected to the input of a means for the generation of a PWM signal, whose output is connected to a controlled switch element of the Cuk-circuitry. The means for the generation of a PWM signal may also be part of a microcontroller.

A circuitry arrangement according to the invention comprising a direct current converter and a load may be embodied so that the load is connected to an output of the direct current converter on the one hand and to the reference potential of the direct current converter on the other hand.

The load may also be connected to an output of the direct current converter on the one hand and to a positive input potential of the direct current converter on the other hand.

A filter, and particularly a passive filter, may be arranged between the output and the load.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 A circuitry arrangement according to the invention comprising a direct current converter according to the invention and a load, only showing the power paths.

FIG. 2 The circuitry arrangement according to FIG. 1, but with representation of a circuit for the control of the direct current converter and

FIG. 3 An extension of the circuitry arrangement according to FIG. 2 for an optimal connection of the load

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

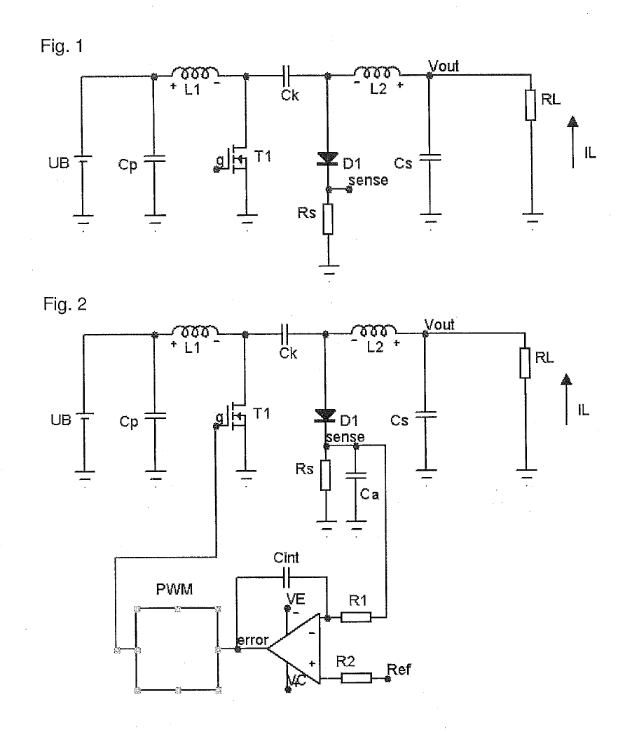

The direct current converter W according to the invention represented in FIGS. 1 to 3 has an input which is connected to a direct current source UB. A load RL, being represented as an ohmic load, is connected to the output of the converter W.

The converter W has a first capacitor Cp connected parallel to the input, which serves the smoothing of the input voltage. This first capacitor may be omitted.

In the converter W, a first choke L1 is connected to the input. The choke is connected to the reference potential with its contact facing away from the input of the converter W via a transistor T1 as a controlled switch. With the same contact, the first choke is connected to a second capacitor Ck.

With its contact facing away from the choke L1, the second capacitor Ck is connected to the output of the converter W via a second choke L2. In addition, this contact of the second capacitor Ck is connected to the anode of a diode D1, called switching diode in the following. A third capacitor Cs is connected in parallel to the output of the converter W.

In so far, the converter W corresponds to a converter known from the prior art. A converter according to the prior art, however, would have a measuring resistor connected in series to the output, across which a voltage drop equivalent to the load current would occur. The converter W according to the invention has a measuring resistor in a different place, namely connected in series to the switching diode D1, between the cathode of the switching diode and the reference potential. The load current IL does not flow through this measuring resistor Rs. Nevertheless, a current flows, and its time average corresponds to the load current IL. Therefore, the voltage drop across the measuring resistor may be used as a signal for the load current after simple average determination.

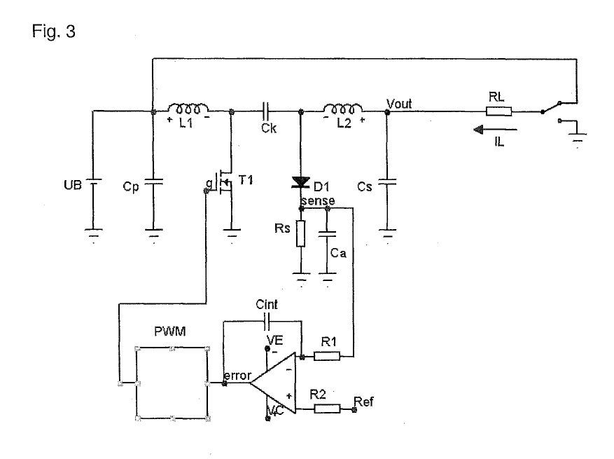

In a first step, the average determination (see FIGS. 2 and 3) may take place by means of a capacitor Ca, which is switched in parallel to the measuring resistor Rs. The voltage across the parallel connection comprising the measuring resistor and the capacitor Ca can be fed into an integrator circuit for a more accurate average determination. To this end, the cathode of the switching diode D1 can be fed into an inverted input of an operational amplifier OP via a resistor R1, as shown in FIGS. 2 and 3. Then, a reference voltage is connected to the non-inverted input of the operational amplifier OP across a further resistor R2. The error output of the operational amplifier OP is, as is customary in integrator circuits, fed back to the inverted input of the operational amplifier OP via a capacitor Cint. Furthermore, the error output is connected with the input of a control PWM, which generates a pulse-width modulated signal for the control of the transistor T1 and whose output is connected to the gate g of the transistor.

The circuit arrangement shown in FIG. 3 corresponds to the circuit arrangement shown in FIG. 2, the circuit arrangement shown in FIG. 2 being complemented by a change-over switch U connected in series to the load RL and by a connection from the change-over switch U to the input of the converter W. By means of the change-over switch, it is possible to change between a so-called Spartopology and a circuit arrangement shown in FIG. 2 without a change to the detection of the load current.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE SIGNS

W Direct current converter
UB Direct current source
Ca Capacitor
Cp First Capacitor
Ck Second capacitor
Cs Third capacitor
Cint Capacitor of the integrator
L1 First choke
L2 Second choke
T1 Transistor
D1 Switching diode
RL Load on output
IL Load current
R1 Resistor
RS Measuring resistor
OP Operational amplifier
U Change-over switch
PWM Controller

1. A direct current converter with Cuk-circuitry and a measuring resistor for load-current recording, wherein the Cuk-circuitry has a switching diode, wherein the measuring resistor is connected in series relative to the switching diode.

2. The direct current converter according to claim 1, wherein the measuring resistor is connected to a cathode of the switching diode with a first connection and to a reference potential of the direct current converter with a second connection.

3. The direct current converter according to claim 1, further comprising a capacitor is connected in parallel to the measuring resistor.

4. The direct current converter according to claim 1, wherein the first connection of the measuring resistor is connected to an input of an integrated circuit, particularly of an operational amplifier a microcontroller.

5. The direct current converter according to claim 1, wherein the first connection of the measuring resistor is connected to an integrator circuit.

6. The direct current converter according to claim 5, wherein one output of the integrator circuit is connected to one input of a means for the generation of a PWM-signal, whose output is connected to a controlled switch element of the Cuk-circuitry.

7. Circuit A circuit arrangement of a direct current converter according to claim 1 and a load, wherein the load is on the one hand connected to an output of the direct current converter and on the other hand to the reference potential of the direct current converter.

8. The circuit arrangement of a direct current converter according to claim 1 and a load, characterized in that the load is on the one hand connected to an output of the direct current converter and on the other hand to a positive potential on the input side of the direct current converter.

9. The circuit arrangement according to claim 7, characterized in that a filter, particularly a passive filter, is arranged between the output and the load.

10. The circuit arrangement according to claim 8, characterized in that a filter, particularly a passive filter, is arranged between the output and the load.
